(19) United States
(12) Patent Application Publication
(10) Pub. No.: US 2022/0221776 A1
(43) Pub. Date: Jul. 14, 2022

(54) Image Processing Method And System For 3D Printing

(71) Applicant: ZHEJIANG XUNSHI TECHNOLOGY CO. LTD, Shaoxing (CN)

(72) Inventors: JING ZHANG, Redondo Beach, CA (US); YONG CHEN, Shaoxing (CN); TUO CHEN, Shaoxing (CN)

(73) Assignee: ZHEJIANG XUNSHI TECHNOLOGY CO. LTD, Shaoxing (CN)

(21) Appl. No.: 17/366,795

(22) Filed: Jul. 2, 2021

(30) Foreign Application Priority Data
Dec. 2, 2020 (CN) 202011404717.4

(51) Int. Cl. G03B 21/134; G03B 21/14; G06V 10/80; B29C 64/393; B29C 64/124

(52) U.S. Cl. CPC G03B 21/134; G03B 21/14; B33Y 50/02; B29C 64/393; B29C 64/124; G06V 10/803

(57) ABSTRACT

An image processing method for 3D printing includes the steps of projecting an initial image on a layer to be printed; shifting the initial image in a first direction, wherein the initial image is shifted by a first distance from an initial position to a first limited position to obtain a first image, wherein the first distance is not greater than a length of one pixel of the initial image in the first direction; fusing the initial image and the first image together to obtain a fused image; and printing the fused image on the layer to be printed.

### CROSS REFERENCE OF RELATED APPLICATION

This is a non-provisional application that claims priority under 35 U.S.C. 119(a-d) to Chinese application number CN 202011404717.4, filed Dec. 2, 2020. The afore-mentioned patent application is hereby incorporated by reference in its entirety.

### BACKGROUND

### 1. Field of the Invention

The present invention primarily relates to the field of image processing. More particularly, the present invention relates to an image processing method and system for 3D printing.

### 2. Discussion of the Related Art

The basic principle of DLP (Digital Light Procession) 3D printing technology is that a digital light source is configured to project light on a surface of liquid photosensitive resin to solidify the photosensitive resin for creating a 3D object through layer-by-layer printing. During the DLP 3D printing, the printable area is composed of a plurality of voxels, wherein the voxels are the units to form the 3D printing. Accordingly, the printer will determine whether to print by identifying the grayscale of the pixels corresponding to the voxels. When the pixel is marked as “white”, the printer will solidify the resin at the pixel location to complete the printing. Otherwise, when the pixel is marked as “black”, the printer will not solidify the resin at this particular pixel location. When the grayscale of the pixel reaches a predetermined level, it will not be printed. When the grayscale reaches a predetermined value, one or more hemispherical blocks will form at the previous printing layer. The brighter the pixel is, the taller the block is, wherein the “voxel” will become wider and slightly taller. In other words, the size of the voxel can be controlled by adjusting the grayscale of a single pixel, and the size of the voxel can be equivalent to the accuracy of the 3D printing.

The existing printing process is to project an image for a layer to be printed and to solidify the layer to be printed to form a layer of the object. For example, when the DLP equipment incorporates with a light engine with a model number 1K95 (1920×1080) to print a 3D object, the pixels are too large, especially it is too obvious for the change of the gray value of the adjacent pixels of the projected image at the contour of the object. So that the connections of the printing surfaces are inconsistent. After the object is made, the surface of the object is rough. Therefore, the disadvantage of the existing DLP 3D printing process is that the contour discontinuity of the object due to the pixelated of the image and the distinguish between pixels so as to for a circular rippling mark on the contour surfaces of the printed object.

Therefore, people who skilled in the art aim to develop an image processing method and system for 3D printing in order to improve the accuracy of grayscale of the pixels without altering the original image resolution for enhancing the transition of the change of the gray value of the adjacent pixels and for reducing the change of the gray value of the adjacent pixels, so as to enhance the surface smoothness of the printed object.

### BRIEF SUMMARY OF THE INVENTION

In view of the above-mentioned shortcomings of the prior art, the present invention is able to solve the technical problem of how to solve the problem of excessive grayscale difference between adjacent pixels of the image without changing the resolution of the original image.

In order to achieve the above objective, the present invention provides an image processing method for 3D printing, which comprises the following steps being executed by a computer.

Project an initial image on a layer to be printed.

Shift the initial image in a first direction, wherein the initial image is shifted by a first distance from an initial position to a first limited position to obtain a first image, wherein the first distance is not greater than a length of one pixel of the initial image in the first direction.

Fuse the initial image and the first image together to obtain a fused image.

Print the fused image on the layer to be printed.

Further, the fusion step further comprises a step of superimposing gray values of the pixels at corresponding positions, i.e. the initial position and the first limited position, of the initial image and the first image.

Further, the initial image is shifted one or more times in the first direction to obtain one or more of the first images; and

Fuse one or more of the first images with the initial image to obtain the fused image.

Further, when the initial image is shifted more than one time in the first direction, the first distances of the initial images are the same each time.

Further, the first distance is half of the length of the pixel in the initial image in the first direction.

The method further comprises the steps of: shifting the first image in a second direction, wherein the first image is shifted by a second distance from the first limited position to a second limited position to obtain a second image, wherein the first distance is perpendicular to the first direction; and

fusing the initial image, the first image and the second image to obtain the fused image.

Further, the second distance is not greater than the length of the pixel of the initial image in the second direction.

Further, the first image is shifted one or more times in the second direction to obtain one or more of the second images; and

Fuse one or more of the second images with the initial image and the first image to obtain the fused image.

Further, when the first image is shifted more than one time in the second direction, the second distances of the first images are the same each time.

Further, the second distance is half of the length of the pixel in the initial image in the second direction.

The method further comprises the steps of: shifting the second image in a third direction, wherein the second image is shifted by a third distance from the second limited position to a third limited position to obtain a third image, wherein the third distance is opposite to the first direction; and

fusing the initial image, the first image, the second image and the third image to obtain the fused image.

Further, the third distance is not greater than the length of the pixel of the initial image in the first direction.

Further, the second image is shifted one or more times in the third direction to obtain one or more of the third images; and

Fuse one or more of the third images with the initial image, the first image and the second image to obtain the fused image.

Further, when the second image is shifted more than one time in the third direction, the third distances of the first images are the same each time.

Further, the number of the second image shifting in the third direction is the same as the number of the initial image shifting in the first direction.

Further, the first distance is half of the length of the pixel in the initial image in the first direction, wherein the initial image shifting in the first direction at one time. In other words, the initial image is shifted in the first direction once.

Further, the second distance is half of the length of the pixel in the initial image in the second direction, wherein the first image shifting in the second direction at one time. In other words, the first image is shifted in the second direction once.

Further, a distance between the first limited position and the third limited position in the first direction is zero.

In accordance with another aspect of the invention, the present invention provides an image processing system for 3D printing, comprising:

an image projector configured for projecting an initial image on a layer to be printed;

a shifting module configured to shift the initial image in a first direction, wherein the initial image is shifted by a first distance from an initial position to a first limited position to obtain a first image, wherein the first distance is not greater than a length of one pixel of the initial image in the first direction;

a fusion module configured to fuse the initial image and the first image together to obtain a fused image; and

a printing module configured to print the fused image on the layer to be print.

The shifting module is further configured to shift the first image in a second direction, wherein the first image is shifted by a second distance from the first limited position to a second limited position to obtain a second image, wherein the first distance is perpendicular to the first direction, wherein the first distance is perpendicular to the first direction, wherein the second distance is not greater than the length of the pixel of the initial image in the second direction.

The shifting module is further configured to shift the second image in a third direction, wherein the second image is shifted at by third distance from the second limited position to a third limited position to obtain a third image, wherein the third direction is opposite to the first direction, wherein the third distance is not greater than the length of the pixel of the initial image in the first direction, wherein a distance between the first limited position and the third limited position is zero.

In accordance with another aspect of the invention, the present invention provides an image processing arrangement for 3D printing, comprising a memory, a processor coupled to the memory, and computer program instructions stored in the memory and being executed by the processor, wherein the processor is configured to execute the above mentioned image processing method.

In accordance with another aspect of the invention, the present invention further provided a computer-readable storage medium which computer program instructions stored in a memory and executed by a processor to implement the above mentioned image processing method.

Comparing with the existing technical solutions, the present invention provides the image processing method and system to reduce the excessive grayscale difference between adjacent pixels of the original image to smoothen the gray transition of the pixels of the image to be displayed on the layer. Therefore, when the DLP 3D printer projects the image on the resin layer to be solidified, the intensity of the light edge distribution will be more uniform, so as to improve the accuracy of 3D printing and to smoothen the contour surface of the printing object.

For a more complete understanding of the present invention with its objectives and distinctive features and advantages, reference is now made to the following specification and to the accompanying drawings.

### BRIEF DESCRIPTION OF THE DRAWING(S)

FIG. 1 is a schematic diagram of a grayscale of an image before shifting in one direction once according to a preferred embodiment of the present invention;

FIG. 2 is a schematic diagram of the grayscale overlay of the image after shifting in one direction once according to the preferred embodiment of the present invention;

FIG. 3 is a schematic diagram of the grayscale of the image before shifting in one direction twice according to the preferred embodiment of the present invention;

FIG. 4 is a schematic diagram of the grayscale overlay of the image after shifting in one direction twice according to the preferred embodiment of the present invention;

FIG. 5 is a schematic diagram of the grayscale of the image before shifting half a pixel according to the preferred embodiment of the present invention;

FIG. 6 is a schematic diagram of the grayscale overlay of the image after shifting half a pixel according to the preferred embodiment of the present invention;

FIG. 7 is a schematic diagram of the grayscale overlay according to the preferred embodiment of the present invention;

FIG. 8 is a schematic diagram of an image shifting process according to the preferred embodiment of the present invention;

FIG. 9 is a flowchart of using the image processing method to improve the accuracy of DLP 3D printing according to the preferred embodiment of the present invention.

### DETAILED DESCRIPTION OF THE INVENTION

In the following description, for purpose of explanation, numerous specific details are set forth in order to provide a thorough understanding of some example embodiments. It will be evident, however, to one of ordinary skill in the art that embodiments of the present invention may be practiced without these specific details.

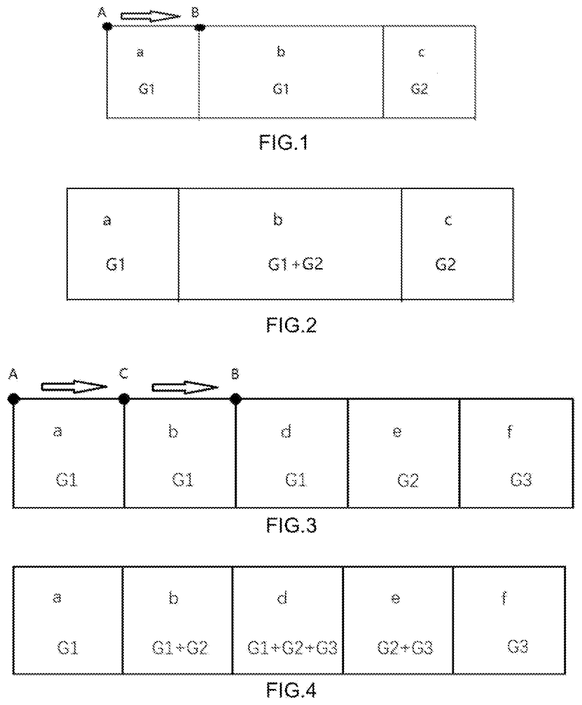

According to the present invention as shown in FIG. 1, an image is configured to shift from an initial position A to a first limited position B in a width direction of the image, wherein a shifting distance between point A and point B is not greater than a width of one pixel of the image. In FIG. 1, a and b refer to predetermined areas in the image before shifting, and b and c refer to the corresponding areas in the image after shifting. As shown in FIG. 1, before shifting, gray values of the image are a:G1, b:G1, c:G2. After overlaying the gray values of the images before and after shifting, area b is a gray-scale fusion area of the image, wherein the gray value of the area b is determined by adding the gray values of the two images before and after shifting at the corresponding positions, which is equal to G1+G2. As shown in FIG. 2, after shifting, the gray values are a:G1, b:G1+G2, c:G2. In other words, after shifting once, the gray value of the initial image area has changed from the original G1 to a portion of G1 and a portion of G1+G2 to achieve a gray level interpolation and to enhance the gray control accuracy. Such configuration equivalents to increases the resolution of the image and regenerate a higher resolution image from the original image.

According to another example of the present invention, the image is shifted twice from the initial position A to position C then to position B in a width direction of the image, wherein a shifting distance between position A and position B is not greater than the width of one pixel of the image. As shown in FIG. 3, a, b, and d refer to predetermined areas in the image before shifting. b, d, and e refer the corresponding image areas after the first shift. d, e, and f refer the corresponding image areas after the second shift. Before shifting, the gray values of the image are: a:G1,b:G1,d:G1,e:G2,f:G3. After shifting twice, the gray values of the image are: a:G1, b:G1+G2, d:G1+G2+G3, e:G2+G3, f:G3. This example not only achieve the gray level interpolation but also enhance the gray level interpolation comparing to shifting the image once from point A to point B, so as to improve the gray control accuracy. Similarly, if the image are shifted multiple times from point A to point B, the result will be enhanced, so that the resolution of the final fusion image will be higher.

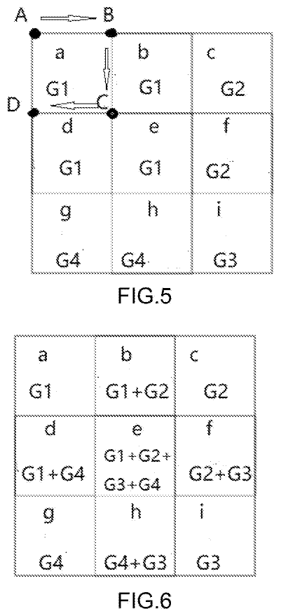

According to another example of the present invention, as shown in FIGS. 5 and 6, the image is shifted once from the initial position A to the first limited position B in a width direction of the image, wherein a shifting distance between position A and position B is half of a width of a pixel of the image. During shifting the image at the second time, the image is shifted from the first limited position B to a second limited position C in a height direction of the image, wherein a shifting distance between position B and position C is half of a height of the pixel of the image. During shifting the image at the third time, the image is shifted from the second limited position C to a third limited position D in the width direction of the image which is opposite direction of the first shift.

For macro analysis, a, b, d, and e in the figure refer to predetermined areas in the image before shifting, wherein the gray value is G1. b, c, e, and f refer to the corresponding images area after the first shift, wherein the gray value G2. e, f, h, and i refer to the corresponding images area after the second shift, wherein the gray value is G3. d, e, g, and h refer to the corresponding images area after the third shift, wherein the gray value is G4. After shifting the images three times with half pixel offset of the image, four images are fused, so that the gray values of the corresponding positions are superimposed to obtain the final fused image, as shown in FIG. 6. The gray levels before shifting the image are a:G1, b:G1, c:G2, d:G1, e:G1, f:G2, g:G4, h:G4, i:G3. The gray values after offset fusion are: a:G1, b:G1+G2, c:G2, d:G1+G4, e:G1+G2+G3+G4, f:G2+G3, g:G4, h:G4+G3, i:G3.

For micro analysis, it could also be understood that a, b, d, and e in FIG. 5 refer to a pixel in the image before the movement, wherein the gray value is G1. b, c, e, and f refer to the corresponding areas of the pixel after shifting half a pixel for the first time, wherein the gray value of this area is G2. e, f, h, i represent the corresponding area of the pixel after the second movement of half a pixel, and the gray value of this area is G3. d, e, g, h refer to the corresponding area of the pixel after the third shift, wherein the gray value of this area is G4. After shifting the images three times with half pixel offset of the image, four images are fused, so that the gray values of the corresponding positions are superimposed to obtain the final fused image, as shown in FIG. 6. The gray levels before the shift are a:G1, b:G1, c:G2, d:G1, e:G1, f:G2, g:G4, h:G4, i:G3. The gray values after offset fusion are: a:G1, b:G1+G2, c:G2, d:G1+G4, e:G1+G2+G3+G4, f:G2+G3, g:G4, h:G4+G3, i:G3. It can be determined that the gray value of the pixel corresponding to the original a, b, d, e has changed from the original single value G1 to a:G1, b:G1+G2, d:G1+G4, e:G1+G2+G3+G4. In other words, a whole original pixel abcd is divided into four new pixels a, b, d, and e, wherein each of new pixels has four different gray values so as to improve the resolution of the image.

As shown in FIGS. 5 and 6, it should be appreciated that whether the macro analysis or micro analysis for the image, without changing the resolution of the original image, more gray values are obtained after shifting the image and the gray control is more accurate that without shifting. By offsetting the width and height of the image by half a pixel, the resolution of the image is improved, so as to obtain a 3D print object with a smoother contour surface.

According to the preferred embodiment, multiple images are merged, or the pixel gray values of multiple images are superimposed, which is processed as follows.

According to the target light engine with resolution of 1920*1080, the size of each pixel is 100 um, the anti-aliasing level is selected as level 2, and the pixel offset is selected as the 2*2 mode. In other words, the offset corresponding to the embodiment shown in FIGS. 5 and 6. After forming four images from one original image through the shifting process, a corresponding area is calculated through anti-aliasing, so that each image will have its own gray scale. A grid map is then generated with the corresponding resolution, wherein the size is 1920*1080, wherein the number of grids is 1920*2*2 in the image width direction, and 1080*2*2 in the image height direction. For each line segment, when it intersects the grid graph, the pixels of the grid are illuminated. Then, a contour map is obtained with a width of 7680 and a height of 4320. By emitting rays to each line of the contour map, the contour can be filled with in and out information, to achieve the fusion of multiple images or the superposition of pixel gray values of multiple images so as to obtain a result image with a higher resolution.

In different examples, the images can be adjusted or processed according to different situations through specific superimposition or fusion process to obtain a smoother transition of the fused image.

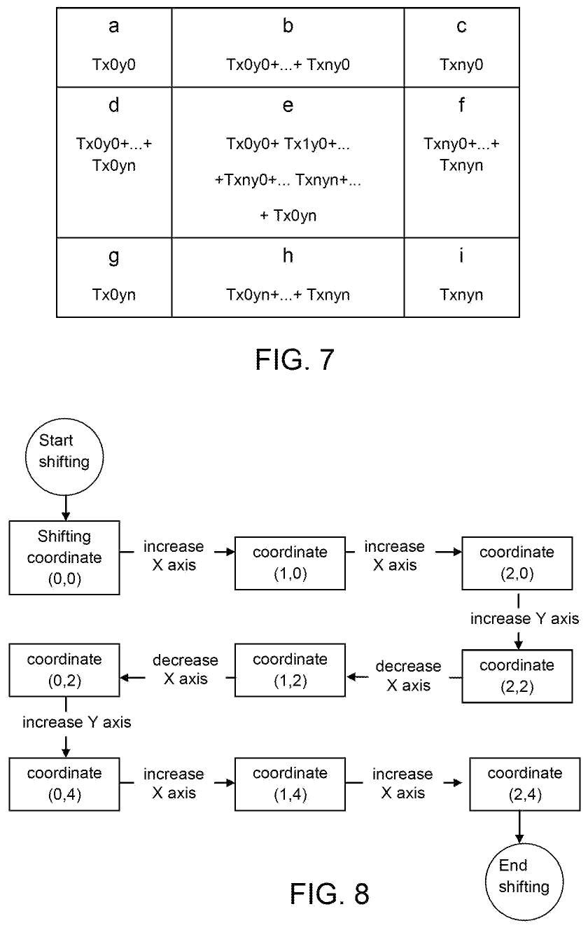

FIG. 7 illustrates a gray scale situation corresponding to another example of the present invention. Through the above mentioned process to project an image for printing a single layer of a printed object, b is the superposition of gray levels from Tx0y0 to Txny0, d is the superposition of Tx0y0 to Tx0yn, e is the gray-scale superposition of Tx0y0 to Txnyn, f is the gray-scale superposition of Txny0 to Txnyn, and h is the gray-scale superposition of Tx0yn to Txnyn. Comparing the image without shifting, the overall grayscale control of the projected image is more accuracy by offsetting or shifting half a pixel. Especially the difference between adjacent gray scales at the edge is reduced, so the jagged condition around the image can be greatly reduced, and the contour surface of the printed object will be smoother.

In another example of the present invention, the image is shifted twice in the width and height directions. FIG. 8 illustrates a specific shifting process of the image. Assume that the width and height of one pixel of the image are set as 3 mm. The image is shifted in the X-axis direction each time, i.e. the width direction, wherein the shifting distance is ⅓ pixel, which is 1 mm. The image is shifted in the Y-axis direction each time, i.e. the height direction, wherein the shifting distance is ⅓ pixel, which is 1 mm. During the shifting process, the shift of coordinate values corresponding to the reference point (0,0) in the image as follows: Move from (0,0) to (1,0) to (2,0) to (2,1) to (1,1) to (0,1) to (0,2) to (1,2) to (2,2).

Similarly, under the conditions that the image is multiple shifted in the width and height directions and the total shifting distance in one direction is controlled not exceed one pixel, the more the image shifts, the smaller the dividing of the image in one single shifting, so as to enhance the accuracy of the gray scale control.

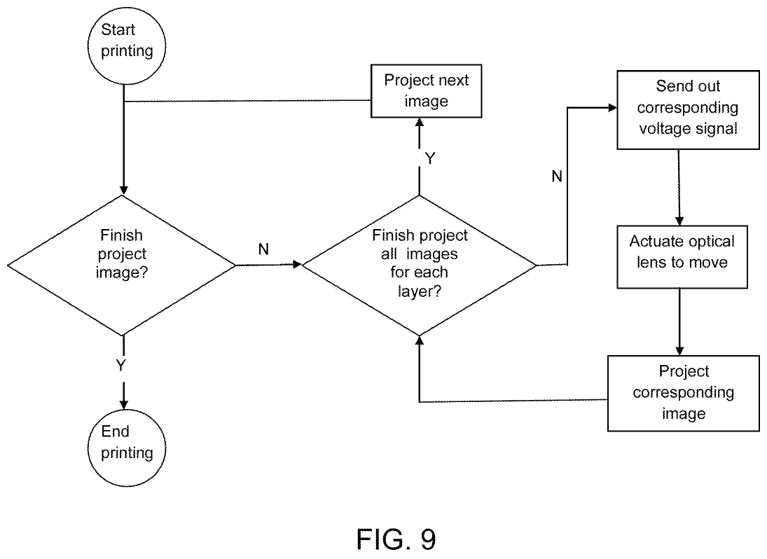

As shown in FIG. 9, the present invention provides an image processing method to improve an accuracy of a DLP 3D printing, which comprises the following steps.

Layer a 3D object to be printed to define a plurality of printing layers.

Operate a light engine. Project an original image on one of the printing layers, shift the original image slightly in width and height directions respectively via a specific shifting method, project another original image after each shift of the original image, overlay and fuse gray values of all the original images, and solidify the printing layer after the original images are fused for a predetermined period of time. Accordingly, the specific methods and processes of shifting the original images and fusing original images are the same as the working principles of the foregoing embodiment and examples.

Starting from the printing layer as the first layer to be printed, repeat the above steps to print each of the printing layers in sequence until all the printing layers are completed to form the 3D object.

When operating the DLP 3D printing, for each printing layer, the image shifting and gray scale fusion are performed similar to the foregoing embodiment and examples. The shifting operation can be performed by operating the light engine to move, operating the optical lens to move, or operating a printing platform to move, wherein the purpose of all of these operations is to shift the image to one position from its previous position. After each shift of the image, the image is project again to superimpose and fuse the gray values to solidify the resin material for a predetermined period of time so as to form the printing layer. Then, one of the light engine, the optical lens, and the printing platform is moved back to its original position, and then repeat the above operation for the next printing layer. Finally, the 3D object with smooth surface will be obtained.

The existing DLP printing method is that: turn on the light engine, project an image, solidify the layer for a predetermined period of time, turn off the light engine, and complete one of the printing layers. Then, project another image to form another printing layer by repeating the above steps. Through the conventional printing method, the change of the gray value of adjacent pixels in the projected image is too obvious at the contour of the object, such that the connecting surfaces of the object will be inconsistent and the surfaces of the object will be roughed after the object is printed.

The present invention provides a technical solution to improve the 3D printing result via an existing low resolution light engine through the above method without using a high resolution light engine. Therefore, the present invention improves the accuracy of DLP printing by reducing the grayscale difference between adjacent pixels of the image. Further, as the number of shifts increases, i.e. as the distance of each micro-displacement is smaller, the grayscale control is more precise and the grayscale difference between adjacent pixels at the contour of the printing object is smaller and smoother. So, the contour of the printing object will be smoother that the rippling mark on the contour of the printing object cannot be seen. Without changing the resolution of the light engine, the printing accuracy can be significantly improved by the present invention in form of software. The method of the present invention has advantages of low hardware cost, good printing effect, and high applicable value.

In addition, the method of the present invention can further be applied for color images. It is known that red, green, and blue are the primary colors of light. Firstly, if the original color of a predetermined point is RGB (R, G, B), the RGB color is converted to grayscale through a converting method. The grayscale of the color image is actually the pixel value after being converted into a black and white image. Then, the method of the present invention is applied to reduce the grayscale difference between adjacent pixels of the image and to increase the grayscale of the image. In other words, the more the gray levels, the clearer and more vivid the image level. Therefore, the method of the present invention is able to improve the resolution of the color image, and to enhance the clarity and realistic of the image.

While the embodiments and examples of the invention have been shown and described for the purposes of illustrating the functional and structural principles of the present invention, it will be apparent to one skilled in the art that various other changes and modifications can be made without departing from the spirit and scope of the invention. Therefore, this invention includes all modifications encompassed within the spirit and scope of the following claims.

1-27. (canceled)

28. An image processing method for 3D printing, comprising the steps, executed by a computer, of:
(a) projecting an initial image on a layer to be printed;
(b) shifting said initial image in a first direction, wherein the initial image is shifted by a first distance from an initial position to a first limited position to obtain a first image, wherein said first distance is not greater than a length of one pixel of said initial image in the said direction;
(c) fusing said initial image and said first image together to obtain a fused image; and
(d) printing said fused image on said layer to be printed.

29. The image processing method, as recited in claim 28, wherein the step (c) further comprises a step of superimposing gray values of said pixels at said initial position and said first limited position of said initial image and said first image respectively.

30. The image processing method, as recited in claim 28, wherein, in the step (b), said initial image is shift one or more times in said first direction to obtain one or more of said first images, such that said one or more of said first images are fused with said initial image to obtain said fused image, wherein said first distances of said initial images are the same each time.

31. The image processing method, as recited in claim 28, wherein said first distance is half of a length of said pixel in said initial image in said first direction.

32. The image processing method, as recited in claim 28, wherein the step (b) further comprises a step of:
(b.1) shifting said first image in a second direction, wherein said first image is shifted by a second distance from said first limited position to a second limited position to obtain a second image, wherein said first distance is perpendicular to said first direction, such that, in the step (c), said initial image, said first image and said second image are fused to obtain the fused image.

33. The image processing method, as recited in claim 32, wherein said second distance is not greater than a length of said pixel of said initial image in said second direction.

34. The image processing method, as recited in claim 32, wherein, in the step (b.1), said first image is shift one or more times in said second direction to obtain one or more of said second images, such that said one or more of said second images are fused with said initial image and said first image to obtain said fused image, wherein said second distances of said first images are the same each time.

35. The image processing method, as recited in claim 32, wherein said second distance is half of a length of said pixel in said initial image in said second direction.

36. The image processing method, as recited in claim 32, wherein the step (b.1) further comprises a step of:
(b.1.1) shifting said second image in a third direction, wherein said second image is shifted by a third distance from said second limited position to a third limited position to obtain a third image, wherein said third distance is opposite to said first direction, such that, in the step (c), said initial image, said first image, said second image and said third image are fused to obtain the fused image.

37. The image processing method, as recited in claim 36, wherein said third distance is not greater than a length of said pixel of said initial image in said first direction.

38. The image processing method, as recited in claim 36, wherein, in the step (b.1.1), said second image is shift one or more times in said third direction to obtain one or more of said third images, such that said one or more of said third images are fused with said initial image, said first image and said second image to obtain said fused image, wherein said third distances of said first images are the same each time.

39. The image processing method, as recited in claim 36, wherein a number of said second image shifting in said third direction is the same as a number of said initial image shifting in said first direction.

40. The image processing method, as recited in claim 36, wherein said first distance is half of a length of said pixel in said initial image in said first direction, wherein said initial image shifting in said first direction at one time.

41. The image processing method, as recited in claim 40, wherein said second distance is half of a length of said pixel in said initial image in said second direction, wherein said first image shifting in said second direction at one time.

42. The image processing method, as recited in claim 41, wherein a distance between said first limited position and said third limited position in said first direction is zero.

43. An image processing arrangement for 3D printing, comprising:
a processor; and
a memory coupled to said processor, wherein said memory stores computer program instructions executed by said processor and configured to:
project an initial image on a layer to be printed;
shift said initial image in a first direction, wherein the initial image is shifted by a first distance from an initial position to a first limited position to obtain a first image, wherein said first distance is not greater than a length of one pixel of said initial image in the said direction;
fuse said initial image and said first image together to obtain a fused image; and
print said fused image on said layer to be printed.

44. The image processing arrangement, as recited in claim 43, wherein said processor is configured to:
shift said first image in a second direction, wherein said first image is shifted by a second distance from said first limited position to a second limited position to obtain a second image, wherein said first distance is perpendicular to said first direction, such that said initial image, said first image and said second image are fused to obtain the fused image

45. The image processing arrangement, as recited in claim 44, wherein said processor is configured to:
shift said second image in a third direction, wherein said second image is shifted by a third distance from said second limited position to a third limited position to obtain a third image, wherein said third distance is opposite to said first direction, such that said initial image, said first image, said second image and said third image are fused to obtain the fused image.

46. The image processing arrangement, as recited in claim 45, wherein said first distance is not greater than a length of said pixel of said initial image in said first direction, wherein said second distance is not greater than said length of said pixel of said initial image in said second direction, wherein said third distance is not greater than a length of said pixel of said initial image in said third direction.

47. The image processing arrangement, as recited in claim 46, wherein a distance between said first limited position and said third limited position in said first direction is zero.
